(19) United States
(12) Patent Application Publication
(10) Pub. No.: US 2003/0065641 A1
(43) Pub. Date: Apr. 3, 2003

(54) Systems and methods for acquiring information associated with an organization having a plurality of units

(76) Inventor: Robert D. Chaloux, Stratford, CT (US)

Correspondence Address: BUCKLEY, MASCHOFF, TALWALKAR, & ALLISON, 5 ELM STREET, NEW CANAAN, CT, 06840, US

(21) Appl. No.: 09/968,210

(22) Filed: Oct. 1, 2001

(51) Int. Cl. G06F 7/00

(52) U.S. Cl. 707/1

(57) ABSTRACT

Systems and methods are provided for acquiring information associated with an organization having a plurality of units. According to one embodiment, a set of questions are transmitted to a number of units associated with an organization. A set of answers are then received in response to the set of questions. Supporting information associated with at least one of the answers may also be received. Some or all of the received information may also be associated with a target result.

### FIELD

The present invention relates to organizations. In particular, the present invention relates to systems and methods for acquiring information associated with an organization having a plurality of units.

### BACKGROUND

Frequently, an organization will need to acquire information from a number of units that are associated with the organization. For example, a business may need to collect information from a number of different departments to determine if each department is complying with policies and procedures that have been established by the business.

Traditionally, such information has been collected by manually distributing a set of questions to each unit (e.g., a printed questionnaire or an electronic spreadsheet to be completed by each unit). There are a number of disadvantages, however, to manually distributing questions to each unit. For example, such an approach may not be practical or efficient, especially if an organization needs to collect information from a large number of units. Moreover, long delays can result when questions are manually distributed (e.g., people who are supposed to provide answers may not know when a questionnaire has been received—or may forget to provide answers in a timely fashion). When a large number of units are involved, it can also be difficult for an organization to determine which units have failed to provide a complete set of answers (e.g., in order to provide appropriate follow-up reminders).

There are also a number of disadvantages to manually receiving answers from a number of different units. For example, a person may be tempted to provide an estimated and/or an overly optimistic answer to a question—especially when the answer reflects his or her performance. Similarly, it can be difficult for an organization to quickly and completely understand the information that has been acquired (e.g., when there are a large number of questions and/or the organization is receiving information from a large number of units). Another potential disadvantage is that the received information (e.g., a printed questionnaire that has been completed by a unit) may inadvertently become available to people who are not authorized to receive the information.

### SUMMARY

To alleviate problems inherent in the prior art, the present invention introduces systems and methods for acquiring information associated with an organization having a plurality of units.

According to one embodiment, a set of questions are transmitted to each of a plurality of units associated with an organization. A set of answers are received from each of the units in response to the set of questions, and it is arranged for received information to be associated with a target result.

According to another embodiment, a set of compliance questions are transmitted to compliance leaders, each compliance leader representing at least one of a plurality of departments associated with a business. A set of answers are then received in response to the compliance questions. The received answers are stored and evaluated, and it is arranged for the stored answers to be associated with a target result. It is also arranged for information to be graphically displayed in accordance with the evaluation.

According to still another embodiment, a set of questions are received from an organization, and a set of answers are transmitted in response to the set of questions. Based on the set of answers, information associated with a target result is received.

According to yet another embodiment, a set of questions are transmitted to each of a plurality of units associated with an organization. A set of answers are received from each of the units in response to the set of questions, and supporting information associated with at least one of the answers is also received.

One embodiment comprises: means for transmitting a set of questions to each of a plurality of units associated with an organization; means for receiving from each of the units a set of answers in response to the set of questions; and means for arranging for received information to be associated with a target result.

Another embodiment comprises: means for transmitting a set of compliance questions to compliance leaders, each compliance leader representing at least one of a plurality of departments associated with a business; means for receiving a set of answers in response to the compliance questions; means for storing the received answers; means for evaluating the stored answers; means for arranging for the stored answers to be associated with a target result; and means for arranging for information to be graphically displayed in accordance with the evaluation.

Still another embodiment comprises: means for receiving a set of questions from an organization; means for transmitting a set of answers to in response to the set of questions; and means for receiving information associated with a target result based on the set of answers.

Yet another embodiment comprises: means for transmitting a set of questions to each of a plurality of units associated with an organization; means for receiving from each of the units a set of answers in response to the set of questions; and means for receiving supporting information associated with at least one of the received answers.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is an information flow diagram according to some embodiments of the present invention.

FIG. 2 is a functional diagram overview of an information system according to some embodiments of the present invention.

FIG. 3 is a block diagram overview of an information system according to some embodiments of the present invention.

FIG. 4 is a flow chart of a method according to some embodiments of the present invention.

FIG. 5 is a block diagram of an organization controller according to an embodiment of the present invention.

FIG. 6 is a tabular representation of a portion of a question database according to an embodiment of the present invention.

FIG. 7 is a tabular representation of a portion of an answer database according to an embodiment of the present invention.

FIG. 8 is a tabular representation of a portion of an organization database according to an embodiment of the present invention.

FIG. 9 is a block diagram of a unit device according to an embodiment of the present invention.

FIG. 10 illustrates a unit device according to an embodiment of the present invention.

FIG. 11 is a flow chart of a method according to another embodiment of the present invention.

FIGS. 12 through 15 illustrate information displays according to some embodiments of the present invention.

### DETAILED DESCRIPTION

Embodiments of the present invention are directed to systems and methods for acquiring information associated with an “organization.” As used herein, the term “organization” may refer to any entity that is interested in acquiring information. An organization may be, for example, a company or a business. An organization may also be a group of companies or businesses (or even a department within a larger organization).

Moreover, embodiments are directed to organizations associated with a plurality of “units.” As used herein, the term “unit” may refer to any entity that is associated with an organization. A unit may be, for example, a department or division (e.g., a legal department), a business area (e.g., a unit associated with real estate transaction), a functional area (e.g., a unit associated with customer service functions), a company (e.g., a subsidiary or franchisee), or a group of employees (e.g., investment advisors). According to one embodiment, a “unit” is simply an employee of an organization.

Information Flow Diagram

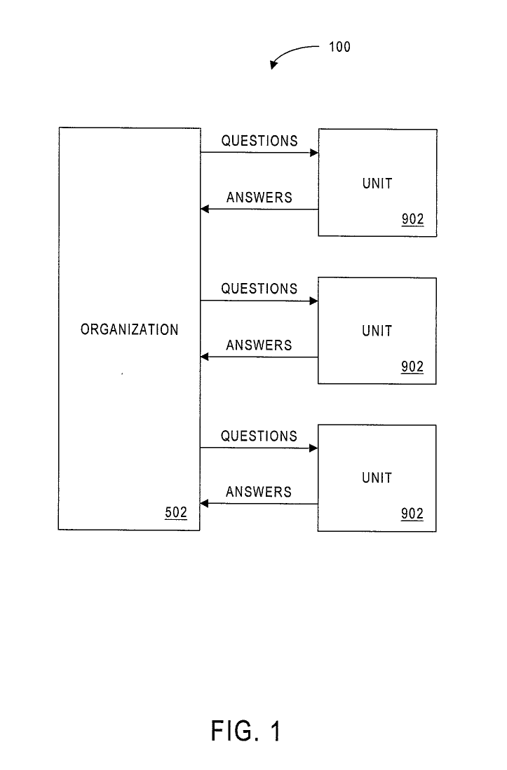

Turning now in detail to the drawings, FIG. 1 is an information flow diagram 100 according to some embodiments of the present invention. As can be seen, an organization 502 transmits a set of questions to each of a plurality of units 902. For example, the organization 502 may transmit a policy questionnaire to each unit 902 (e.g., via an Intranet Web site).

According to one embodiment, the same set of questions are transmitted to each unit 902. According to another embodiment, different units 902 can receive different sets of questions (e.g., a questionnaire may be customized based on a functional area or a past performance associated with a unit 902).

The organization 502 then receives a set of answers from each unit 902. For example, the organization 502 may receive a complete set of answers after a unit 902 has completed a questionnaire (e.g., via an Intranet Web site). According to another embodiment, the organization 502 receives answers on an answer-by-answer basis (e.g., an answer may be transmitted from a unit 902 to the organization 502 each time a response to an individual question is provided).

According to some embodiments of the present invention, information received by the organization 502 is then associated with a target result. For example, the organization 502 may compare a set of answers received from a unit 902 with a set of target answers (e.g., to determine if a unit 902 is meeting a series of performance goals). The organization 502 may also assign a value or score associated with a set of answers (e.g., indicating that a unit 902 has met fifty percent of its performance goals) and compare that value with a target result.

According to one embodiment, the organization 502 associates received information with a target result by establishing the target result based on the received information. For example, the organization 502 may evaluate a set of answers received from a unit 902 and determine that the unit 902 currently has a “sixty percent” compliance rating (e.g., six out of ten answers indicate that the unit 902 is complying with an organization policy). Based on this information, the organization 502 may establish a target result of “eighty percent” for that unit 902 (e.g., the unit 902 may need to increase the compliance rating from sixty percent to eighty percent within one year). According to one embodiment, the target result is established by a person (e.g., a employee associated with the organization 502 may establish the target result after reviewing a set of answers and discussing the answers with an employee associated with the unit 902). According to another embodiment, the target result is automatically established (e.g., by increasing the current compliance rate a pre-determined amount or a predetermined percentage).

Information System Functions

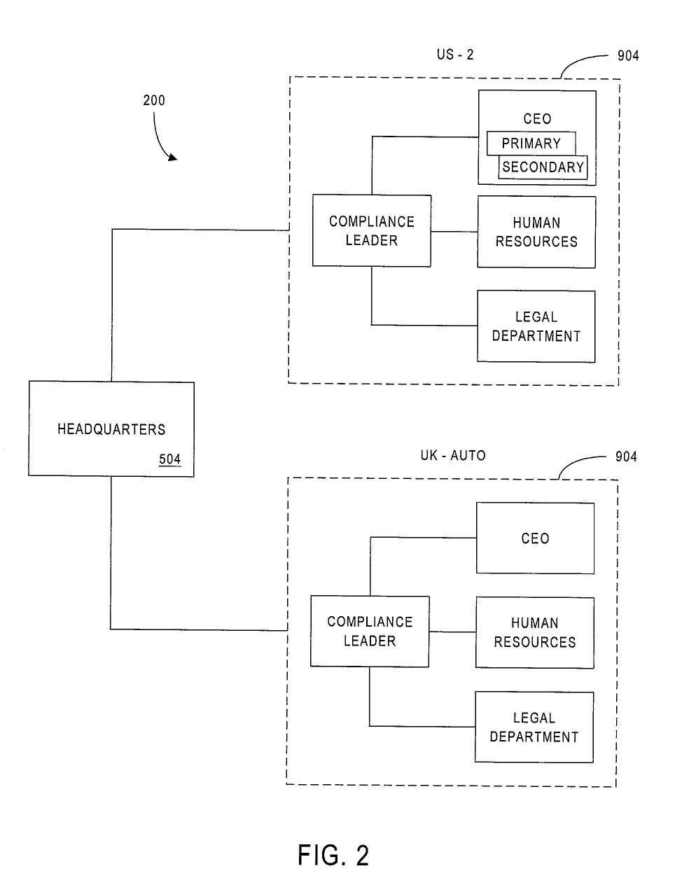

FIG. 2 is a functional diagram overview of an information system 200 according to some embodiments of the present invention. In this case, a headquarters 504 (e.g., an “organization”) is associated with a number of businesses 904 (e.g., a “US-2 business unit” and a “UK-Auto business unit”). As illustrated in FIG. 2, each business 904 may include a compliance leader associated with a number of different departments. For example, the compliance leader may be associated with a Chief Executive Officer (CEO), a human resources department, and a legal department.

According to some embodiments of the present invention, headquarters 504 transmits a set of questions to each business 904. For example, headquarters 504 may transmit questions directly to each department within the business 904 or to the compliance leader (e.g., who then forwards some or all of the questions to each department).

According to one embodiment, each department within a business 904 further includes a primary owner and a secondary owner. The primary owner may be, for example, responsible for answering one or more questions received from headquarters 504. That is, the compliance leader may be associated with all questions received from headquarters 504 and the primary owner may be associated with subset of those questions. A primary owner may be, for example, a CEO, a business functional leader, a human resources department, a quality leader, a legal department, or a process owner. Note that a single employee may act as both a compliance leader and a primary owner for a department (e.g., a CEO may be responsible for making sure that fifty questions are answered by someone—as well as for providing his or her own answers for three of those questions). The role of the secondary owner may be to assist the primary owner (e.g., to gather information needed to answer one or more questions).

Headquarters 504 may then receive a set of answers from each business 904. For example, headquarters 504 may receive answers from a compliance leader or from a department (e.g., from a primary or secondary owner). According to one embodiment, headquarters 504 also associates received information with a target result (e.g., by establishing a target result based on a set of answers received from a business 904).

Information System Overview

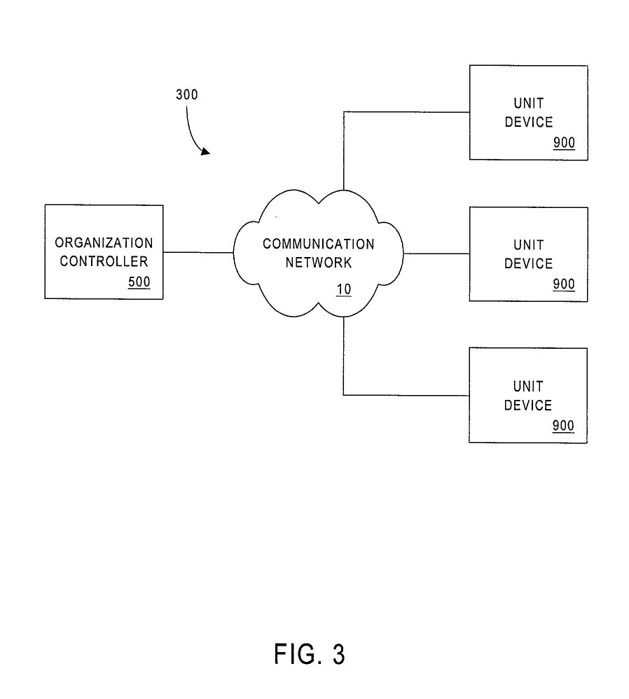

FIG. 3 is a block diagram overview of an information system 300 according to some embodiments of the present invention. The information system 300 includes an organization controller 500 that communicates with a number of unit devices 900 via a communication network 10. The communication network 10 may comprise, for example, a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network (e.g., in accordance with an 802.11 standard), and/or an Internet Protocol (IP) network such as the Internet, an intranet, or an extranet. According to one embodiment, the organization controller 500 transmits information to different unit devices 900 via different communication networks. According to another embodiment, the organization controller 500 transmits information to a unit device 900 via a first communication network and receives information from the unit device 900 (or another device) via a second communication network.

Although a single organization controller 500 is shown in FIG. 3, any number of organization controllers 500 may be included in the information system 300. Similarly, any number of unit devices 900 may associated with a single unit according to embodiments of the present invention.

The organization controller 500 and the unit devices 900 may be any devices capable of performing the various functions described herein. The organization controller 500 may be, for example, a Web server or an e-mail server. A unit device 900 may be, for example: a personal computer (PC), a portable computing device such as a Personal Digital Assistant (PDA), or any other appropriate storage and/or communication device. According to one embodiment, a unit device 900 is a PC capable of running a Web browser, such as the INTERNET EXPLORER® 5.0 Web browser available from MICROSOFT CORP.®

Note that the devices shown in FIG. 3 need not be in constant communication. For example, the organization controller 500 may communicate with a unit device 900 on an as-needed or periodic basis.

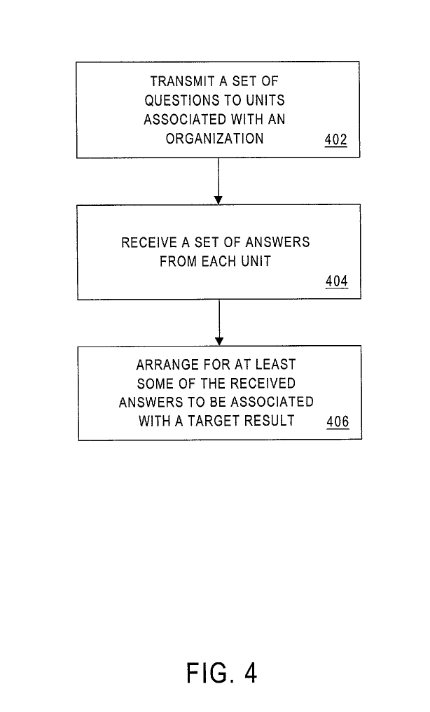

FIG. 4 is a flow chart of a method that may be performed by the organization controller 500 according to some embodiments of the present invention. The flow charts in FIG. 4 and the other figures described herein do not imply a fixed order to the steps, and embodiments of the present invention can be practiced in any order that is practicable.

At 402, a set of questions is transmitted to each of a plurality of units associated with an organization. For example, the organization controller 500 may transmit a set of questions to a number of unit devices 900 (e.g., via a Web site or electronic mail messages).

The questions may comprise, for example, compliance questions associated with a program assessment questionnaire. Such a program assessment questionnaire may include, for example, infrastructure questions (e.g., how often is compliance adherence and strategy communicated to employees), risk prioritization questions (e.g., has the business assessed risks and prioritized compliance requirements with respect to internal policies), issues identification questions (e.g., are all new product launchings reviewed by the legal department), risk assessment questions (e.g., is there a process in place to monitor open compliance issues), ombuds program questions (e.g., have ombudspersons been identified and trained), and/or training program questions (e.g., are all new employees introduced to compliance issues).

The questions may also comprise, for example, compliance questions associated with a policy assessment questionnaire. Such a policy assessment questionnaire may include, for example, questions about working with customers and suppliers (e.g., is there a process in place to identify improper use of company funds), questions about competing globally (e.g., are global price increase guidelines followed), questions about the unit's role in the organization and the community (e.g., are fire escape procedures in place), questions about protecting organization assets (e.g., do employees have a procedure available to initiate patent applications for new ideas), and/or questions about government business (e.g., is that unit involved with local government agencies).

Other examples of questions that may be transmitted include legal questions (e.g., does the unit comply with applicable export restrictions) and survey questions (e.g., which of the following does the unit need most from headquarters). According to one embodiment, the questions comprise multiple-choice questions. For example, potential answers may comprise “yes” or “no,” “true” or “false,” a numerical rating (e.g., from one to ten), a single selection (e.g., “A,” “B,” or “C”), or multiple sections (e.g., “A” and “C”).

According to one embodiment, the organization arranges for the set of questions to be translated before being transmitted to a unit. For example, the organization may translate questions and potential answers into different languages before being transmitted to units in different countries.

According to another embodiment, the organization receives from a unit a request for supplemental information associated with the set of questions. For example, a compliance leader or primary owner may ask for further information to clarify a particular question. The organization may then transmit the supplemental information to the unit in response to the request (e.g., to explain the meaning of a phrase used in a question).

At 404, a set of answers is received from a unit in response to the questions. For example, the organization controller 500 may receive a set of answers from a unit device 900 (e.g., via a Web site or one or more electronic mail messages).

According to one embodiment, the organization also receives supporting information associated with an answer. Consider, for example, the following question: “How often does your unit hold compliance meetings?” In this case, the primary owner may need to attach documents (e.g., meeting minutes) to support his or her answer that compliance meetings are held on a monthly basis. The supporting information may comprise, for example, a supporting document, an indication of a supporting document (e.g., a link to a document or a Web page), text information (e.g., the text of a memo may be attached to an answer), image information, and/or audio information. According to some embodiments, the supporting information is mandatory (e.g., some questions may require that supporting information be provided).

At 406, it is arranged for received information to be associated with a target result. For example, the organization controller 500 may compare some or all of the answers received from a unit device 900 with a target result. As another example, the organization controller 500 may establish a target result for a unit based on the answers received from a unit device 900.

According to one embodiment, it is arranged for the received answers to be stored (e.g., in a database). For example, the received answers may be stored by (or at) the organization controller 500 or a unit device 900.

According to some embodiments, the organization controller 500 further arranges for information to be displayed in accordance with the received answers (e.g., by arranging for the information to be displayed to a user associated with the organization or unit). The information may be compiled from, for example, a plurality of units, a plurality of answers (e.g., an overall compliance average may be computed for an entire organization), a question type (e.g., a compliance average may be computed for a particular question), a region (e.g., a compliance average may be computed for all units in Asia), a country (e.g., a compliance average may be computed for all units in Japan), and/or a particular unit.

The information may then be displayed, for example, on an organization-wide basis, a unit basis, a plurality of units basis, a unit-to-unit basis (e.g., to compare the performance of two different units), and/or unit-to-average basis (e.g., to compare the performance of a particular unit with the entire organization).

The displayed information may include one or more organization goals. For example, an organization may establish a number of five year goals associated with one or more questions. The displayed information may also include baseline information (e.g., indicating a unit's prior performance level), actual information (e.g., indicating a unit's current performance level), predicted information, target information (e.g., indicating a level at which a unit should be performing), and/or gap information (e.g., indicating a difference between an actual performance level and a target performance level).

The information may be presented to a user, for example, as text or numeric information. For example, a compliance percentage may be displayed to a CEO for each unit or for each question. The information may also be presented graphically. For example, a bar graph may display a unit's actual performance level along with a target performance level. According to one embodiment, color information is also used in the display (e.g., a number or a bar graph may be “red” when an actual performance level falls below a target performance level by a pre-determined amount).

The display presented to a user may reflect, for example, substantially real-time information, periodic information (e.g., when information is compiled on a daily or quarterly basis), and/or historic information (e.g., indicating a unit's prior performance level). According to one embodiment, the organization controller 500 also generates a report in accordance with the received answers (e.g., by printing a report for a user).

According to one embodiment, the organization controller 500 receives from a user a request to access a set of questions or answers. For example, a user may attempt to add a question, delete a question, or modify a question. Similarly, a user may attempt to view information associated with a unit or with an entire organization. In either case, the organization controller 500 may determine an access level associated with the received request. The access level may permit, for example, viewing question information, editing question information, and/or viewing answer information. For example, a compliance leader might be allowed to view information associated with an entire business while a primary owner is only allowed to view information associated with his or her department. An access level may also let a user adjust user groups (e.g., by changing a primary or secondary owner of a particular question).

According to another embodiment, a notification is automatically generated and transmitted. For example, if an answer is not received from a unit within a pre-determined period of time (e.g., three days), a reminder notification may be transmitted to a compliance leader or a primary owner. Similarly, a notification may be transmitted if required supporting information is not received along with an answer. According to another embodiment, a notification is transmitted to another party. For example, a notification may be transmitted to headquarters if an answer is not received within three weeks (e.g., indicating that someone from headquarters should contact the appropriate compliance leader or primary owner). A confirmation message can also be transmitted (e.g., to a unit's compliance leader) after a complete set of answers has been received (e.g., from a number of different departments within a unit).

According to another embodiment, the organization controller 500 also evaluates the received answers. For example, the organization controller 500 may compare an actual result with a target result. Based on this comparison, the organization controller 500 may establish an adjusted target result (e.g., to reflect that a unit has already met a previous target result), a target date (e.g., a date by which a unit should meet a target result), and/or an action item (e.g., indicating specific steps that should be taken by a unit). In addition, the organization controller 500 may arrange for a penalty or a reward to be provided based on the evaluation. For example, a manager may receive an increased bonus when his or her department meets a target result.

Organization Controller

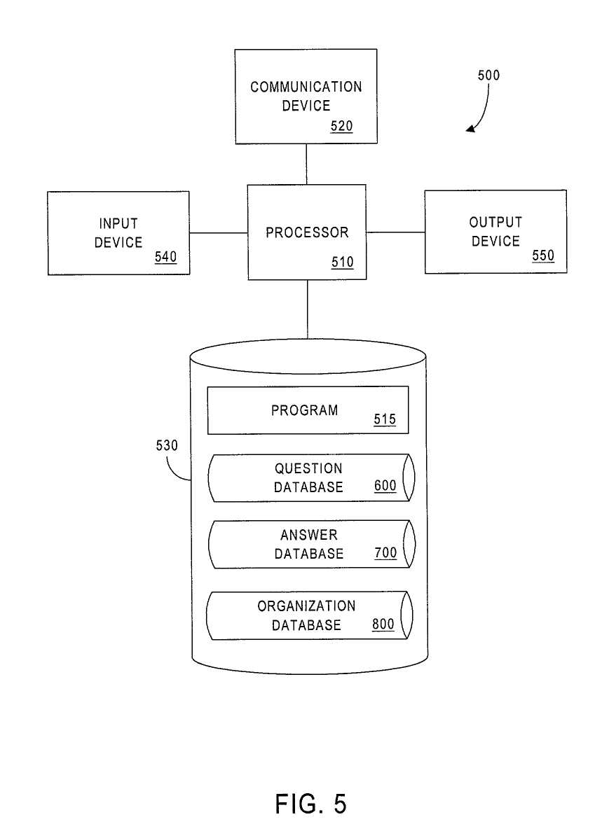

FIG. 5 illustrates an organization controller 500 that is descriptive of the device shown, for example, in FIG. 3 according to some embodiments of the present invention. The organization controller 500 comprises a processor 510, such as one or more INTEL® Pentium® processors, coupled to a first communication device 520 configured to communicate via a communication network (not shown in FIG. 5). The communication device 520 may be used to communicate, for example, with one or more unit devices 900.

The processor 510 is also in communication with an input device 540. The input device 540 may comprise, for example, a keyboard, a mouse or other pointing device, a microphone, an infrared port, a docking station, and/or a touch screen. Such an input device 540 may be used, for example, to enter questions that will be transmitted to unit devices 900.

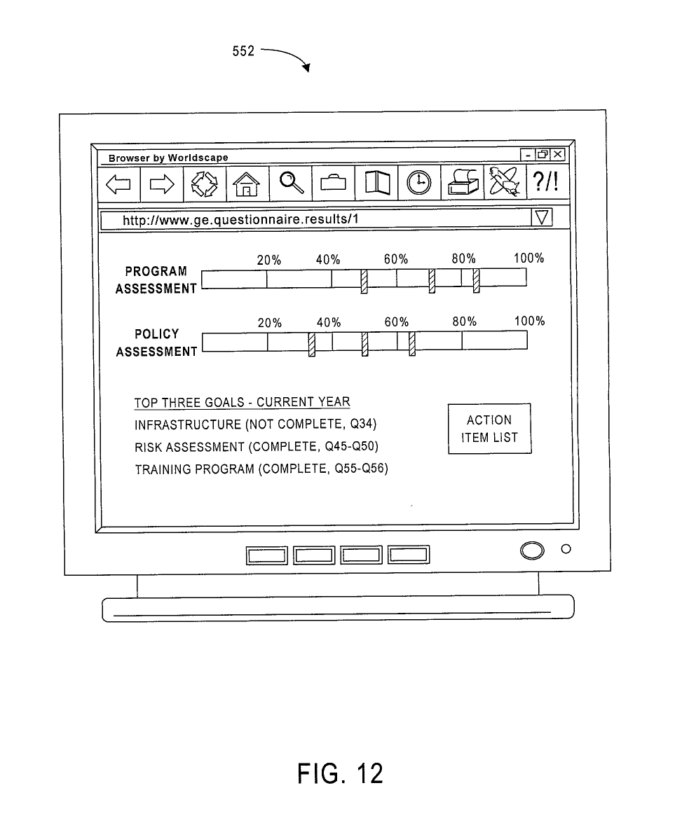

The processor 510 is also in communication with an output device 550. The output device 550 may comprise, for example, a display (e.g., a computer monitor), a speaker, and/or a printer. The output device 450 may be used, for example, to display information complied from a number of unit devices 900. Examples of such information displays are described herein with respect to FIGS. 12 through 15.

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 stores a program 515 for controlling the processor 510. The processor 510 performs instructions of the program 515, and thereby operates in accordance with the present invention. For example, the processor 510 may transmit a set of questions to a number of unit devices 900 associated with an organization. The processor 510 may also receive a set of answers from a unit device 900 and arrange for received information to be associated with a target result.

According to one embodiment, the processor 510 transmits a set of compliance questions to a number of compliance leaders. The processor 510 then receives from each compliance leader a set of answers in response to the compliance questions. The received answers are stored and evaluated, and it is arranged for the stored answers to be associated with a target result. The processor 510 also arranges for information to be graphically displayed in accordance with this evaluation.

According to another embodiment, the processor 510 transmits a set of questions to a number of unit devices 900 and receives from a unit device a set of answers along with supporting information associated with at least one answer.

As used herein, information may be “received” by or “transmitted” to, for example: (i) the organization controller 500 from a unit device 900; or (ii) a software application or module within the organization controller 500 from another software application, module, or any other source.

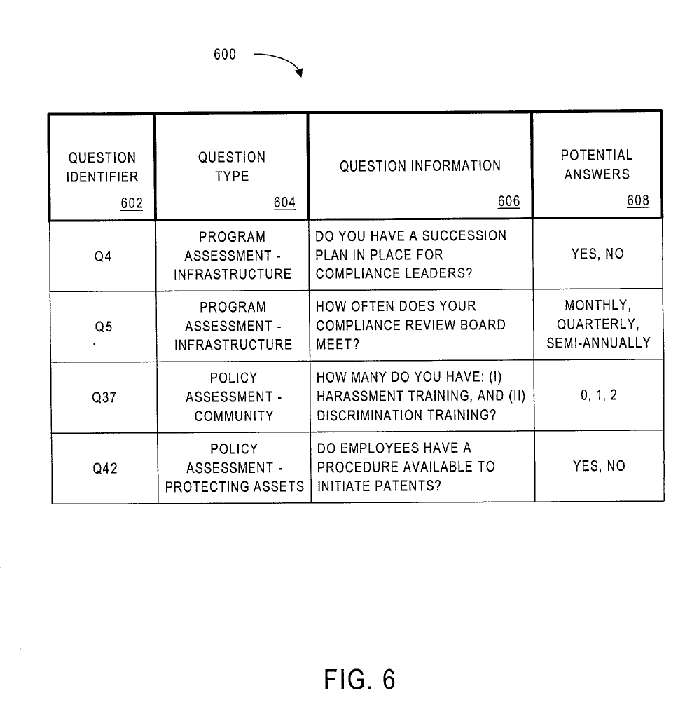

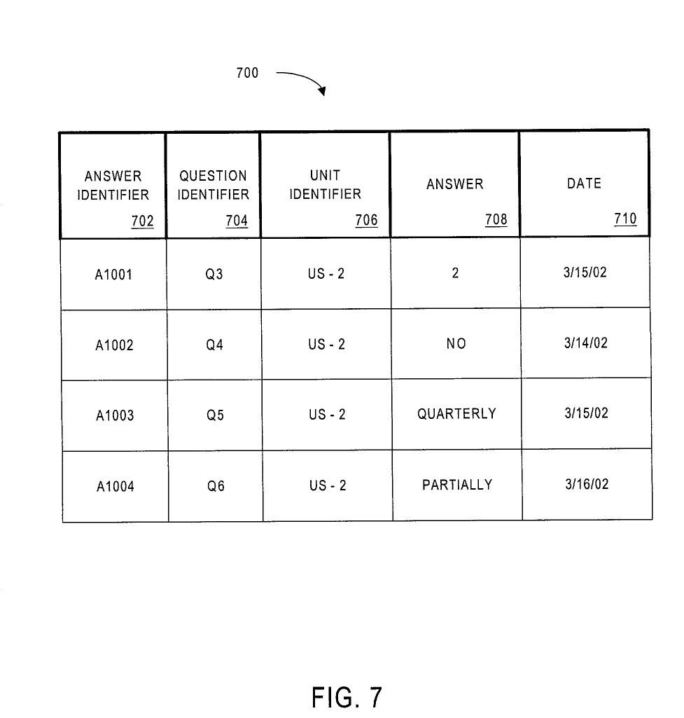

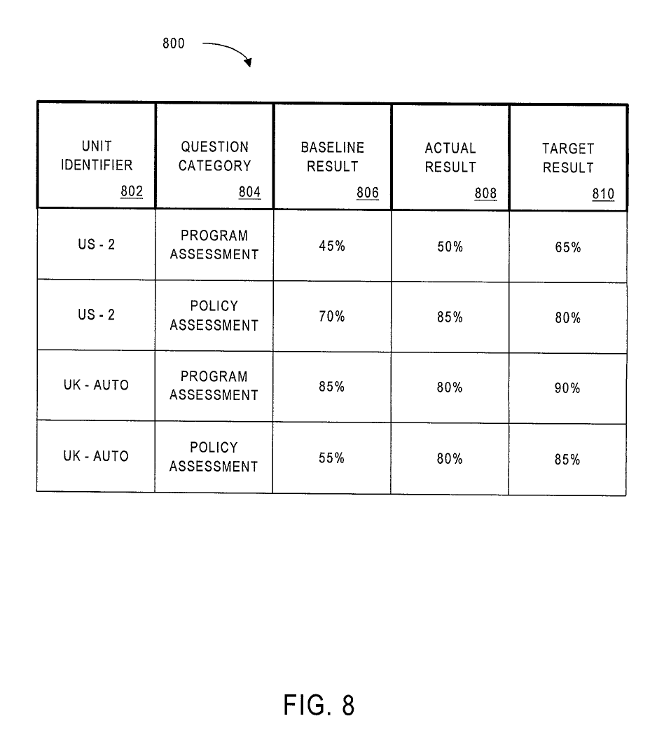

As shown in FIG. 5, the storage device 530 also stores a question database 600 (described with respect to FIG. 6), an answer database 700 (described with respect to FIG. 7), and an organization database 800 (described with respect to FIG. 8). Examples of databases that may be used in connection with the organization controller 500 will now be described in detail. The illustrations and accompanying descriptions of the databases presented herein are exemplary, and any number of other database arrangements could be employed besides those suggested by the figures.

Question Database

Referring to FIG. 6, a table represents the question database 600 that may be stored at the organization controller 500 according to an embodiment of the present invention. The table includes entries identifying questions that may be transmitted via the information system 300. The table also defines fields 602, 604, 606, 608 for each of the entries. The fields specify: a question identifier 602, a question type 604, question information 606, and potential answers 608. The information in the question database 600 may be created and updated, for example, based on information received from a user associated with an organization (e.g., a CEO).

The question identifier 602 may be, for example, an alphanumeric code associated with a question that may be transmitted via the information system 300. The question type 604 indicates a category associated with the question (e.g., whether a particular question is a program or policy assessment question).

The question information 606 may include, for example, text, graphic, and/or audio information. The question information 606 may be transmitted to (and displayed by) a user device 900. The potential answers 608 indicate how a user may respond to the question. For example, as illustrated by the fourth entry in the question database 600, a user may answer the question “Do employees have a procedure available to initiate patents?” with either a “yes” or a “no.”

Other information may also be stored in the question database 600. For example, each question (or question type) may be associated with a primary and secondary owner (e.g., a particular user identifier).

Answer Database

Referring to FIG. 7, a table represents the answer database 700 that may be stored at the organization controller 500 according to an embodiment of the present invention. The table includes entries identifying answers that have been received via the information system 300. The table also defines fields 702, 704, 706, 708, 710 for each of the entries. The fields specify: an answer identifier 702, a question identifier 704, a unit identifier 706, an answer 708, and a date 710. The information in the question database 700 may be created and updated, for example, based on information received from primary owners (e.g., via unit devices 900).

The answer identifier 702 may be, for example, an alphanumeric code associated with an answer that has been received via the information system 300. The question identifier 702 may be, for example, an alphanumeric code associated with a question and may be based on, or associated with, the question identifier 602 stored in the question database 600.

The unit identifier 706 indicates the unit, unit device 900, or primary owner who provided the answer 708 (e.g., an answer 708 selected from the potential answers 608 stored in the question database 600). The date 710 indicates when the answer 708 was received by the organization controller 500.

Other information may also be stored in the answer database 700. For example, supporting information (e.g., a link to a supporting document) may be stored in the answer database 700 when appropriate.

Organization Database

Referring to FIG. 8, a table represents the organization database 800 that may be stored at the organization controller 500 according to an embodiment of the present invention. The table includes entries identifying information associated with a unit. The table also defines fields 802, 804, 806, 808, 810 for each of the entries. The fields specify: a unit identifier 802, a question category 804, a baseline result 806, an actual result 808, and a target result 810. The information in the organization database 800 may be created and updated, for example, based on information stored in the question database 600 and the answer database 700.

The unit identifier 802 may be may be, for example, an alphanumeric code that indicates a unit associated with an organization. The question category 804 indicates a type of question and may be based on, or associated with, the question type 604 stored in the question database 600.

The organization database 800 also stores average compliance information that has been complied for a number of different units and question categories 804. For example, the baseline result 806 indicates a prior performance of a unit with respect to a particular question category 804. As illustrated by the third entry in FIG. 8, the “UK-Auto” unit previously had an eighty five percent compliance score with respect to “program assessment” questions. The organization database 800 similarly includes the actual result 808 (e.g., indicating a current compliance score) and the target result 810 (e.g., indicating a compliance score that should be achieved).

Unit Device

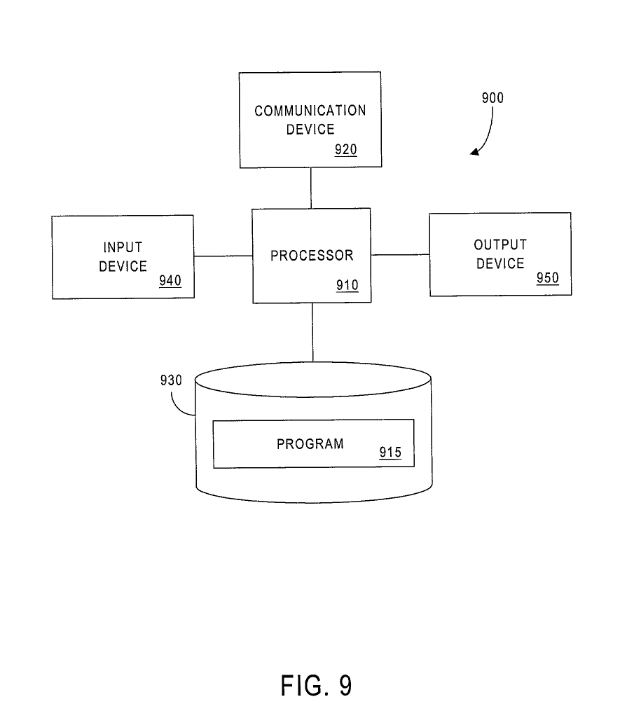

FIG. 9 illustrates a unit device 900 that is descriptive of the device shown, for example, in FIG. 3 according to some embodiments of the present invention. The unit device 900 comprises a processor 910, such as one or more INTEL® Pentium® processors, coupled to a communication device 920 configured to communicate via a communication network (not shown in FIG. 9). The communication device 920 may be used to communicate, for example, with one or more organization controllers 500.

The processor 910 is also in communication with an input device 940. The input device 940 may comprise, for example, a keyboard, a mouse or other pointing device, a microphone, a scanner (e.g., to input an image of a supporting document), and/or a touch screen. Such an input device 940 may be used, for example, to provide answers and supporting information via the unit device 900.

The processor 910 is also in communication with an output device 950. The output device 950 may comprise, for example, a display (e.g., a display screen), a speaker, and/or a printer. The output device 950 may be used, for example, to receive questions via the unit device 900.

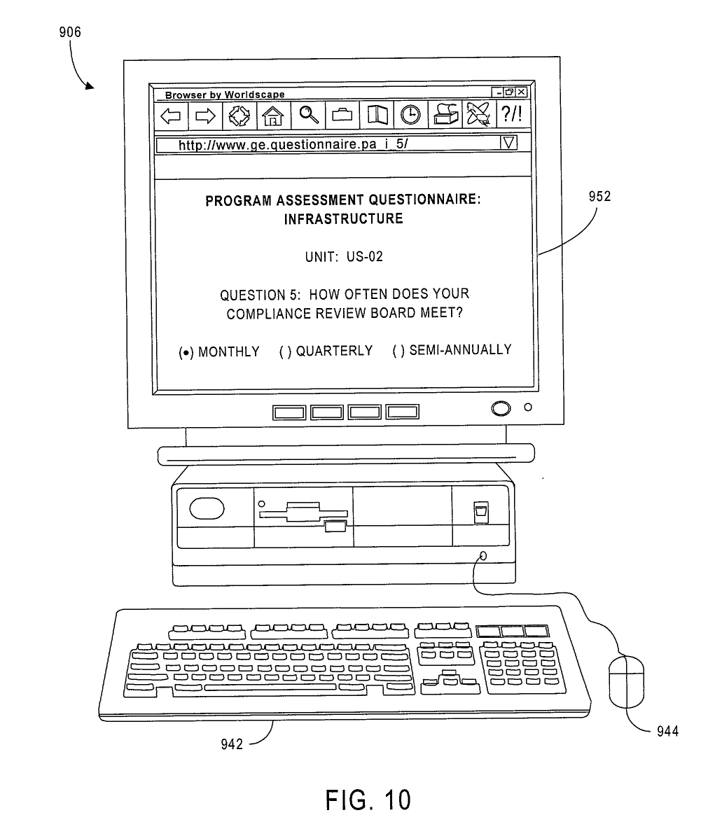

For example, FIG. 10 illustrates a PC 906 being used as a unit device 900 according to an embodiment of the present invention. The PC 906 includes a computer keyboard 942 and mouse 944 being used as input devices 940 and a computer monitor 952 being used as an output device 950. In particular, the monitor 952 illustrates a policy assessment question being displayed to a user. The user may then answer the question via the keyboard 942 and/or the mouse 944.

Referring again to FIG. 9, the processor 910 is also in communication with a storage device 930. The storage device 930 may comprise any appropriate information storage device, including combinations of magnetic storage devices, optical storage devices, and/or semiconductor memory devices such as RAM devices and ROM devices.

The storage device 930 stores a program 915 for controlling the processor 910. The processor 910 performs instructions of the program 915, and thereby operates in accordance with the present invention. For example, the processor 910 may receive a set of questions from an organization controller 500 and transmit a set of answers to in response to the questions. The processor 910 may also receive information associated with a target result based on the set of answers.

As used herein, information may be “received” by or “transmitted” to, for example: (i) the unit device 900 from the organization controller 500; or (ii) a software application or module within the unit device 900 from another software application, module, or any other source.

Information System Methods

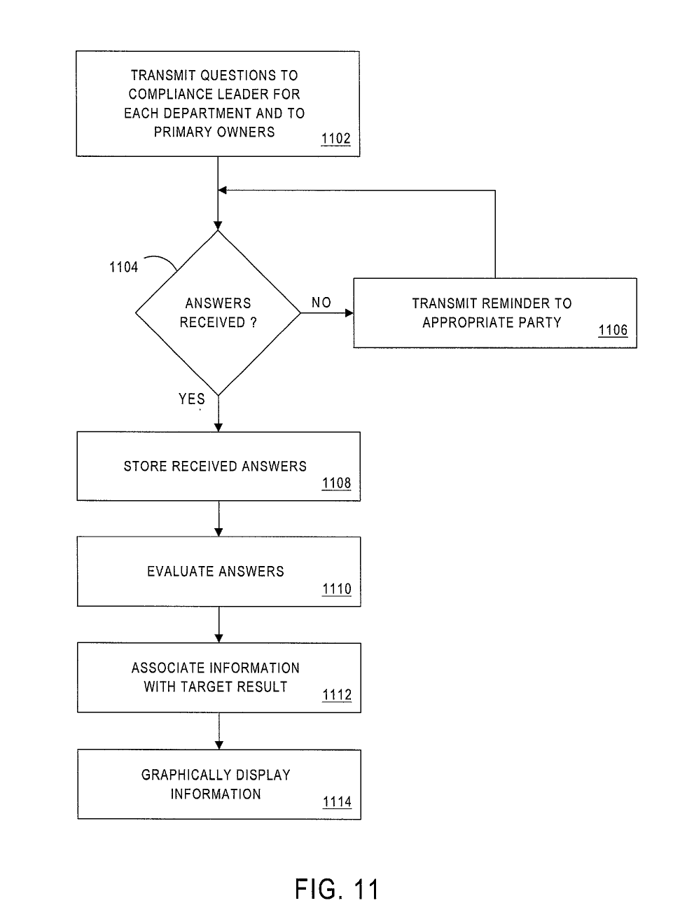

FIG. 11 is a flow chart of an information system method according to one embodiment of the present invention. The method may be performed, for example, by an organization controller 500 associated with a business. At 1102, a set of compliance questions are transmitted to compliance leaders associated with a number of departments (i.e., “units” within the business). For example, question information 606 and potential answers 608 may be retrieved from the question database 600 and transmitted to a number of unit devices 900 (e.g., via an Intranet).

If answers have not been received at 1104, a reminder is transmitted to an appropriate party at 1106. For example, if the organization controller 500 has not received an answer within five days, a reminder message may be transmitted to the compliance leader (e.g., via an automated telephone message). As another example, an electronic mail message may be automatically transmitted to the compliance leader's supervisor (e.g., the CEO of the business) if an answer has not been received within four weeks.

When answers have been received at 1104, the set of answers are stored at 1108. For example, the organization controller 500 may store the answers in the answer database 700 (e.g., along with any supporting information). The answers are then evaluated at 1110 (e.g., to determine an actual result 808 to be stored in the organization database 800).

At 1112, the answers are associated with a target result. For example, the organization controller 500 may determine a target result 810 for a unit based on the actual result 808 stored in the organization database 800.

At 1114, information is graphically displayed. For example, the organization controller 500 may display a bar graph to a CEO in accordance with the baseline result 806, the actual result 808, and/or the target result 810 stored in the organization database 800. Some specific examples of information displays will now be provided with respect to FIGS. 12 through 15.

Information Displays

FIGS. 12 through 15 illustrate information displays according to some embodiments of the present invention. In particular, FIG. 12 illustrates an information display 552 that shows program and policy assessment information in graphical form based on information received from a number of units (e.g., average compliance scores for the entire organization). For example, the program assessment information is represented as a bar chart that ranges from zero to one hundred percent compliance. The bar chart has three markers (shown as shaded areas in FIG. 12): a baseline result (i.e., the left-most marker), an actual result (i.e., the center marker), and a target result (i.e., the right-most marker). The policy assessment information is similarly displayed.

The display 552 also includes the top three goals for the organization during the current year along with a status of each goal (e.g., “complete” or “not complete”) and an indication of the question or questions that are associated with each goal. The display also includes an “action item” area that may be activated to display a list of steps that need to be taken by the organization or by a unit (along with status information and one or more dates associated with each step).

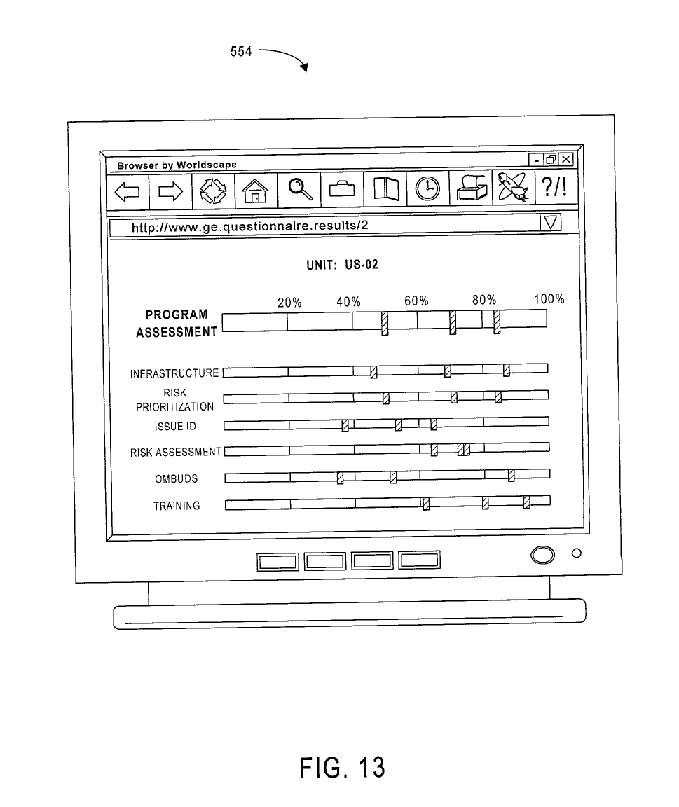

FIG. 13 illustrates an information display 554 that provides a more detailed indication of the program assessment information. That is, program assessment information for a number of different categories (i.e., “infrastructure” and “risk prioritization”) are provided for a particular unit (i.e., “US-02”).

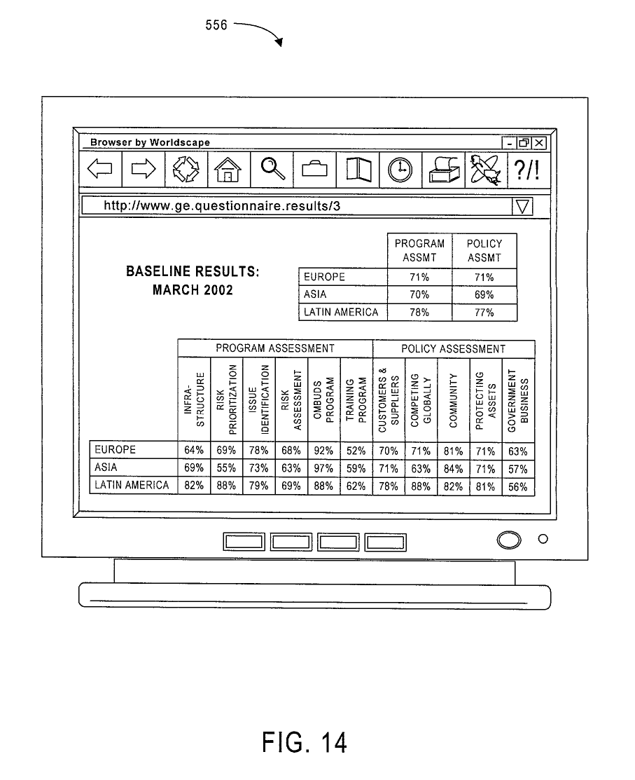

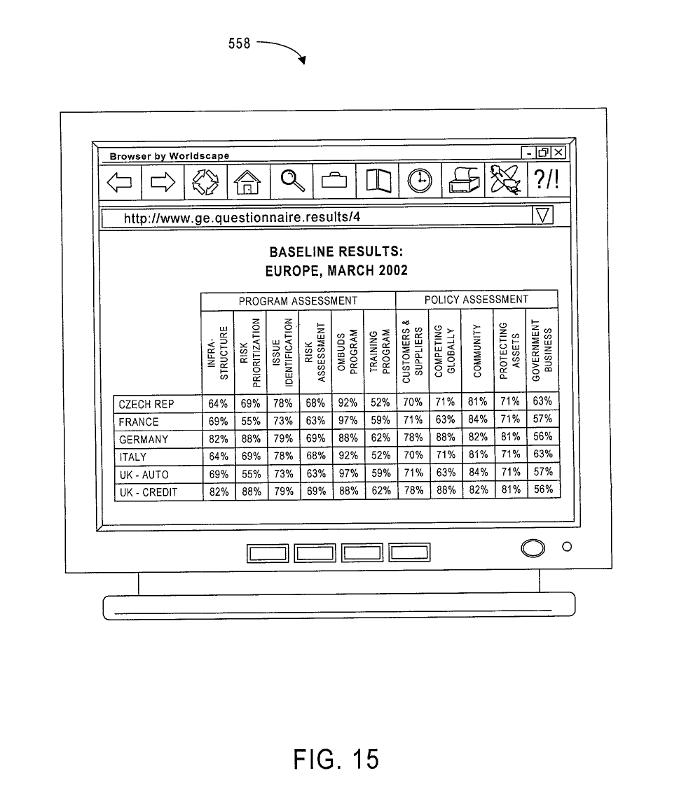

FIG. 14 illustrates an information display 556 that includes numerical baseline results for a number of different geographic areas (e.g., policy assessment results for “Latin America”). FIG. 15 illustrates a more detailed information display 558 indicating baseline results for particular units (e.g., policy assessment results associated with “competing globally” for the “UK-Credit” unit).

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments of the present invention have been described with respect to particular types of organizations, the present invention can be used with any type of organization. For example, the present invention may be used to acquire information for a trade association or a government agency that has a number of units.

Similarly, although many embodiments have been described with respect to an organization controller 500, some or all of the functions performed by the organization controller 500 may instead be performed by a unit device 900 or any other device. For example, a unit device 900 may automatically calculate a target result and/or a target date (e.g., based on a formula supplied by the organization controller 500).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of acquiring information associated with an organization having a plurality of units, comprising:
transmitting a set of questions to each of the units;
receiving from each of the units a set of answers in response to the set of questions; and
arranging for received information to be associated with a target result.

2. The method of claim 1, wherein the organization comprises at least one of: (i) a company, (ii) a group of companies, and (iii) a department.

3. The method of claim 1, wherein the units comprise at least one of: (i) business areas, (ii) functional areas, (iii) departments, (iv) companies, (v) groups of employees, and (vi) employees.

4. The method of claim 1, wherein each unit is associated with a compliance leader, and each question is associated with a primary owner.

5. The method of claim 4, wherein each question is further associated with a secondary owner.

6. The method of claim 4, wherein a primary owner is associated with at least one of: (i) a chief executive officer, (ii) a business functional leader, (iii) a human resources department, (iv) a quality leader, (v) a legal department, and (vi) a process owner.

7. The method of claim 1, wherein the questions comprise at least one of: (i) compliance questions, (ii) program assessment questions, (iii) policy assessment questions, (iv) legal questions, (v) survey questions, and (vi) multiple-choice questions.

8. The method of claim 1, wherein the set of questions are associated with a program assessment questionnaire and comprise at least one of: (i) infrastructure questions, (ii) risk prioritization questions, (iii) issues identification questions, (iv) risk assessment questions, (v) ombuds program questions, and (vi) training program questions.

9. The method of claim 1, wherein the set of questions are associated with a policy assessment questionnaire and comprise at least one of: (i) questions about working with customers and suppliers, (ii) questions about competing globally, (iii) questions about the unit's role in the organization, (iv) questions about protecting organization assets, and (v) questions about government business.

10. The method of claim 1, wherein at least one of said transmitting and receiving are performed via at least one of: (i) the Internet, (ii) an intranet, (iii) a public network, (iv) a public switched telephone network, (v) a proprietary network, (v) a wireless network, and (vi) a local area network.

11. The method of claim 1, wherein at least one of said transmitting and receiving are performed via at least one of: (i) an organization controller, (ii) a unit device, (iii) a personal computer, (iv) a server, (v) a portable computing device, (vi) a telephone, (vii) a Web site, and (viii) an electronic mail message.

12. The method of claim 1, wherein said transmitting and receiving are performed via a communication network.

13. The method of claim 1, wherein said transmitting is performed via a first communication network and said receiving is performed via a second communication network.

14. The method of claim 1, wherein said arranging comprises establishing a target result for a unit based on the set of answers received from the unit.

15. The method of claim 1, wherein said arranging comprises comparing a target result for a unit based on the set of answers received from the unit.

16. The method of claim 1, further comprising:
storing the received answers, wherein said storing is performed via at least one of: (i) an organization controller, and (ii) a unit device.

17. The method of claim 1, further comprising:
receiving supporting information associated with at least one of the received answers.

18. The method of claim 17, wherein the supporting information comprises at least one of: (i) a supporting document, (ii) an indication of a supporting document, (iii) text information, (iv) image information, and (v) audio information.

19. The method of claim 1, further comprising:
arranging for information to be displayed in accordance with the received answers.

20. The method of claim 19, wherein the displayed information comprises information compiled from at least one of: (i) a plurality of units, (ii) a plurality of answers, (iii) a question type, (iv) a region, (v) a country, and (vi) a unit.

21. The method of claim 19, wherein the displayed information is displayed on at least one of: (i) an organization basis, (ii) unit basis, (iii) a plurality of units basis, (iv) a unit-to-unit basis, and (v) unit-to-average basis.

22. The method of claim 19, wherein the information is displayed to a user associated with at least one of: (i) the organization, and (ii) a unit.

23. The method of claim 19, further comprising:
arranging for at least one of the following to be displayed: (i) organization goals, (ii) baseline information, (iii) actual information, (iv) target information, and (v) gap information.

24. The method of claim 19, wherein the displayed information comprises at least one of: (i) text information, (ii) numeric information, (iii) percentage information, (iv) graphical information, (v) bar graph information, and (vi) color information.

25. The method of claim 19, wherein the displayed information comprises at least one of: (i) substantially real-time information, (ii) periodic information, and (iii) historic information.

26. The method of claim 1, further comprising:
generating a report in accordance with the received answers.

27. The method of claim 1, further comprising:
receiving a request to access at least one of: (i) the set of questions, and (ii) the received answers.

28. The method of claim 27, further comprising:
determining an access level associated with the received request.

29. The method of claim 28, wherein the access level permits at least one of: (i) viewing question information, (ii) editing question information, (iii) viewing answer information, and (iv) adjusting user groups.

30. The method of claim 1, further comprising:
if an answer is not received from a unit within a predetermined period of time, transmitting a reminder notification.

31. The method of claim 1, further comprising:
if an answer is not received from a unit within a pre-determined period of time, transmitting a notification to another party.

32. The method of claim 1, further comprising:
transmitting a confirmation that a complete set of answers have been received.

33. The method of claim 1, further comprising:
evaluating the received answers.

34. The method of claim 33, wherein said evaluating comprises comparing an actual result to the target result.

35. The method of claim 34, further comprising:
based on said comparing, establishing at least one of: (i) an adjusted target result, (ii) a target date, and (iii) an action item.

36. The method of claim 34, further comprising:
based on said evaluating, arranging for at least one of: (i) a penalty and (ii) a reward.

37. The method of claim 1, further comprising:
arranging for the set of questions to be translated prior to said transmitting.

38. The method of claim 1, further comprising:
receiving from a unit a request for supplemental information associated with the set of questions; and
transmitting the supplemental information to the unit in response to the request.

39. A computer-implemented method of acquiring information associated with a business having a plurality of departments, comprising:
transmitting a set of compliance questions to a compliance leader associated with each of the departments;
receiving a set of answers in response to the set of compliance questions;
storing the received answers;
evaluating the stored answers;
arranging for the stored answers to be associated with a target result; and
arranging for information to be graphically displayed in accordance with the evaluation.

40. An apparatus, comprising:
a processor; and
a storage device in communication with said processor and storing instructions adapted to be executed by said processor to:
transmit a set of questions to each of a plurality of units associated with an organization,
receive from each of the units a set of answers in response to the set of questions, and
arrange for received information to be associated with a target result.

41. The apparatus of claim 40, wherein said storage device further stores at least one of: (i) a question database, (ii) an answer database, and (iii) an organization database.

42. The apparatus of claim 40, further comprising:
communication device coupled to said processor and adapted to communicate with at least one of: (i) an information controller, and (ii) a unit device.

43. A medium storing instructions adapted to be executed by a processor to perform a method of acquiring information associated with an organization having a plurality of units, said method comprising:
transmitting a set of questions to each of the units;
receiving from each of the units a set of answers in response to the set of questions; and
arranging for received information to be associated with a target result.

44. A method of providing information associated with an organization having a plurality of units, comprising:
receiving a set of questions from the organization;
transmitting a set of answers to in response to the set of questions; and
based on the set of answers, receiving information associated with a target result.

45. A method of acquiring information associated with an organization having a plurality of units, comprising:
transmitting a set of questions to each of the units;
receiving from each of the units a set of answers in response to the set of questions; and
receiving supporting information associated with at lease one of the received answers.
